(19) United States
(12) Patent Application Publication
(10) Pub. No.: US 2009/0214202 A1
(43) Pub. Date: Aug. 27, 2009

(54) Selecting Wavelengths And Routes In An Optical Network

(75) Inventors: Youichi Akasaka, Allen, TX (US); Takao Naito, Plano, TX (US)

Correspondence Address: BAKER BOTTS L.L.P., 2001 ROSS AVENUE, SUITE 600, DALLAS, TX, 75201-2980, US

(73) Assignee: Fujitsu Limited, Kanagawa (JP)

(21) Appl. No.: 12/253,281

(22) Filed: Oct. 17, 2008

Related U.S. Application Data
(60) Provisional application No. 61/030,290, filed on Feb. 21, 2008.

(51) Int. Cl. H04B 10/08

(52) U.S. Cl. 398/29

(57) ABSTRACT

Selecting a wavelength and a route includes facilitating communication through routes among nodes. Each route is associated with a plurality of wavelengths and comprises one or more segments that couple one node to another node. A polarization mode dispersion value is determined for each wavelength of each route to yield polarization mode dispersion values for each route. A wavelength and a route are selected according to the polarization mode dispersion values.

### RELATED APPLICATION

This application claims benefit under 35 U.S.C. §119(e) of U.S. Provisional Application Ser. No. 61/030,290, entitled “PMD Aware Routing and Wavelength Assignment,” Attorney's Docket 064731.0690, filed Feb. 21, 2008, by Youichi Akasaka et al.

### TECHNICAL FIELD

This invention relates generally to the field of communications and more specifically to selecting wavelengths and routes in an optical network.

### BACKGROUND

In optical networks, polarization mode dispersion (PMD) may degrade optical signals transmitted through optical fiber. Accordingly, techniques may be used to address polarization mode dispersion.

### SUMMARY OF THE DISCLOSURE

In accordance with the present invention, disadvantages and problems associated with previous techniques for selecting wavelengths and routes in an optical network may be reduced or eliminated.

According to one embodiment, a wavelength and a route includes facilitating communication through routes among nodes. Each route is associated with a plurality of wavelengths and comprises one or more segments that couple one node to another node. A polarization mode dispersion value is determined for each wavelength of each route to yield polarization mode dispersion values for each route. A wavelength and a route are selected according to the polarization mode dispersion values.

Certain embodiments of the invention may provide one or more technical advantages. A technical advantage of one embodiment may be that differential group delays for different wavelengths of routes may be determined. The polarization mode dispersion of the routes may be calculated from the differential group delays of the different wavelengths. Calculating polarization mode dispersion in this manner may yield a more accurate estimate of polarization mode dispersion. A wavelength and route may be selected according to the polarization mode dispersion of the wavelengths.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates one embodiment of an optical network for which paths may be selected according to differential group delay (DGD) of the paths;

FIGS. 2A through 2D illustrate examples of the dependency of differential group delay on wavelength;

FIG. 3 illustrates one embodiment of a polarization mode dispersion (PMD) module that may select paths according to differential group delay; and

FIG. 4 illustrates one embodiment of method that may be performed by a polarization mode dispersion module to select paths according to differential group delay.

### DETAILED DESCRIPTION OF THE DRAWINGS

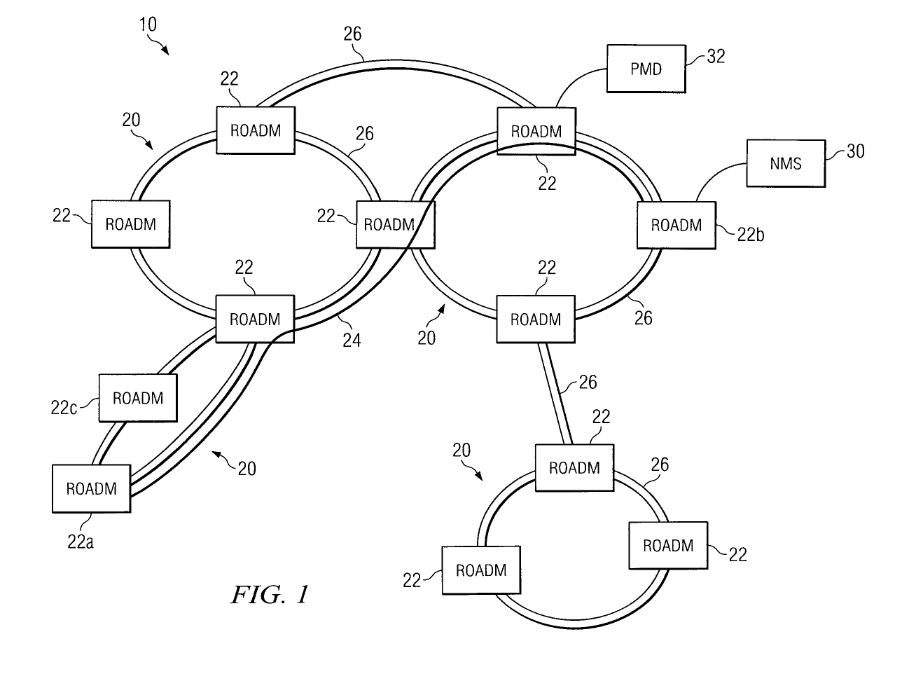

Embodiments of the present invention and its advantages are best understood by referring to FIGS. 1 through 4 of the drawings, like numerals being used for like and corresponding parts of the various drawings.

FIG. 1 illustrates one embodiment of an optical network 10 for which paths may be selected according to the differential group delay (DGD) of the paths, which indicates the polarization mode dispersion (PMD) of the paths. In certain embodiments, the differential group delays for different wavelengths of routes may be determined.

In particular embodiments, network 10 represents a communication network that allows components, such as nodes, to communicate with other components. A communication network may comprise all or a portion of one or more of the following: a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, other suitable communication link, or any combination of any of the preceding.

In particular embodiments, network 20 communicates information through signals. A signal may comprise an optical signal transmitted as light pulses. As an example, an optical signal may have a frequency of approximately 1550 nanometers and a data rate of 10, 20, 40, 100, or over 100 gigabits per second (Gbps). A signal may comprise a synchronous transport signal (STS) that communicates information in packets. Information may include voice, data, audio, video, multimedia, control, signaling, and/or other information.

In particular embodiments, network 10 includes ring networks 20. According to one embodiment, ring network 20 may utilize protocols such as Resilient Packet Ring (RPR) protocols, according to which packets are added, passed through, or dropped at each network node 22. Ring network 20 may utilize any suitable routing technique, such as Generalized Multi-Protocol Label Switching (GMPLS) techniques. Ring network 20 may utilize any suitable transmission technique, such as wavelength division multiplexing (WDM) techniques.

In particular embodiments, a ring network 20 includes network nodes 22 and spans 26. Network nodes 22 may include any suitable device configured to route packets through, to, or from ring network 20. Examples of network elements include routers, switches, wavelength division multiplexers (WDMs), access gateways, endpoints, softswitch servers, trunk gateways, access service providers, Internet service providers, a network management system 30, or other device configured to route packets through, to, or from ring network 20. In the illustrated embodiment, network nodes 22 include dynamic reconfigurable optical add and drop multiplexer (d-ROADM) nodes and a PMD apparatus 32, described below.

In particular embodiments, spans 26 represent any suitable fibers configured to transmit a signal, such as optical fibers. A span 26 communicates one or more channels, where a channel represents a particular wavelength. A wavelength may be identified by a wavelength channel identifier. A segment may be a span that couples one node 22 to another node 22.

In particular embodiments, a route 24 of nodes 22 and spans 26 may be associated with one or more wavelengths, for example, may communicate light signals of one or more wavelengths. A path of a signal may be a particular wavelength of a particular route. A route may comprise one or more segments, for example, may comprise a plurality of segments from source node 22a to a destination node 22b, or may comprise one segment from one node 22a to a next node 22c.

Polarization mode dispersion (PMD) of spans 26 may degrade the transmission of optical signals. Polarization mode dispersion is a form of modal dispersion where two different polarizations of light in a fiber (or waveguide), which normally travel at the same speed, travel at different speeds due to random imperfections and asymmetries of the fiber. The different speed of travel causes random spreading of optical pulses. Polarization mode dispersion may dynamically change in response to environmental influence.

The pulse spreading effects have a mean polarization-dependent time-differential Δτ, or differential group delay (DGD), proportional to the square root of propagation distance L:

Δτ=D_{PMD}\sqrt{L}

D_{PMD} represents the PMD parameter of the fiber, which measures the strength and frequency of the imperfections. The PMD parameter may be measured in picosecond/√kilometer (ps/√km).

In particular embodiments, PMD module 32 manages the polarization mode dispersion information of network 10. The operations of PMD module 32 may be performed by one or more apparatuses, such as by a node 20, network management system 30, and/or other apparatus.

In particular embodiments, PMD module 32 may obtain, store, and/or distribute polarization mode dispersion information. For example, PMD module 32 may measure polarization mode dispersion and/or access a database that includes polarization mode dispersion information.

In particular embodiments, a node 20 or other apparatus may determine polarization mode dispersion between itself and adjacent nodes 20 for each wavelength. Node 20 may then broadcast polarization mode dispersion information over the network to other nodes 20. In particular embodiments, a network management system 30 or other apparatus may gather, store, and/or distribute the polarization mode dispersion information.

In particular embodiments, PMD module 32 may treat polarization mode dispersion as a wavelength dependent fiber characteristic, and may determine differential group delays for different wavelengths of routes 24. PMD module 32 may also select a path, a combination of wavelength and route, according to the differential group delays. For example, PMD module 32 may select a path with acceptable polarization mode dispersion for particular wavelengths. As another example, the apparatus may not select a path with unacceptable polarization mode dispersion for particular wavelengths.

A component of network 10 may include an interface, logic, memory, and/or other suitable element. An interface receives input, sends output, processes the input and/or output, and/or performs other suitable operation. An interface may comprise hardware and/or software.

Logic performs the operations of the component, for example, executes instructions to generate output from input. Logic may include hardware, software, and/or other logic. Logic may be encoded in one or more tangible media and may perform operations when executed by a computer. Certain logic, such as a processor, may manage the operation of a component. Examples of a processor include one or more computers, one or more microprocessors, one or more applications, and/or other logic.

In particular embodiments, the operations of the embodiments may be performed by one or more computer readable media encoded with a computer program, software, computer executable instructions, and/or instructions capable of being executed by a computer. In particular embodiments, the operations of the embodiments may be performed by one or more computer readable media storing, embodied with, and/or encoded with a computer program and/or having a stored and/or an encoded computer program.

A memory stores information. A memory may comprise one or more tangible, computer-readable, and/or computer-executable storage medium. Examples of memory include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

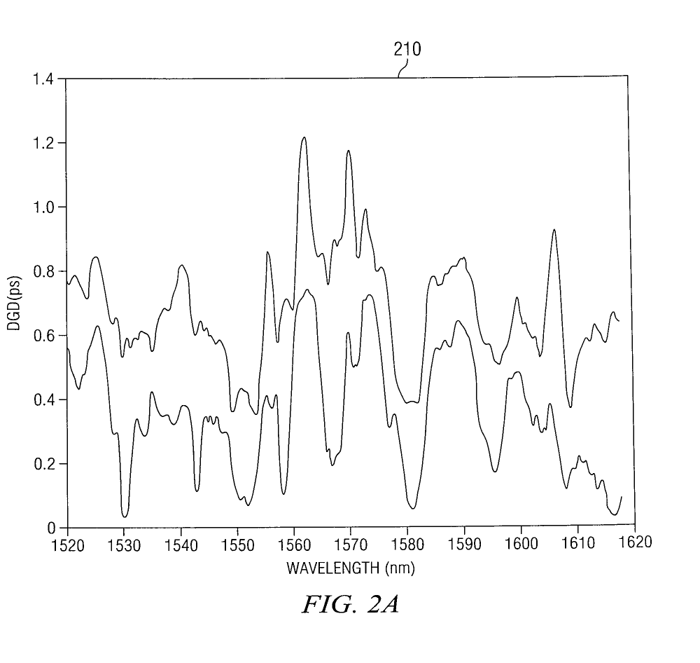

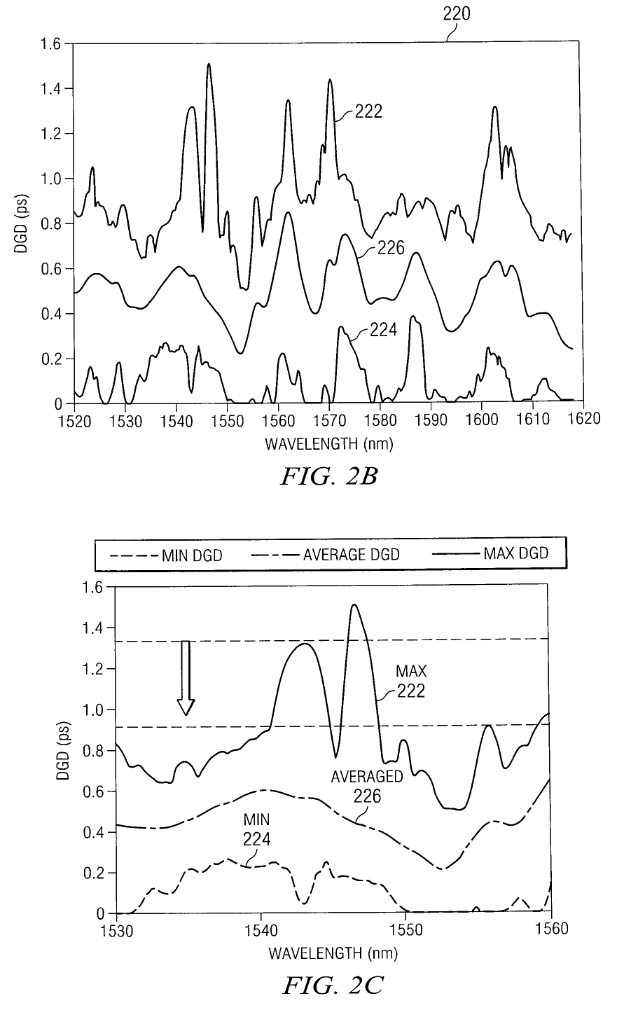

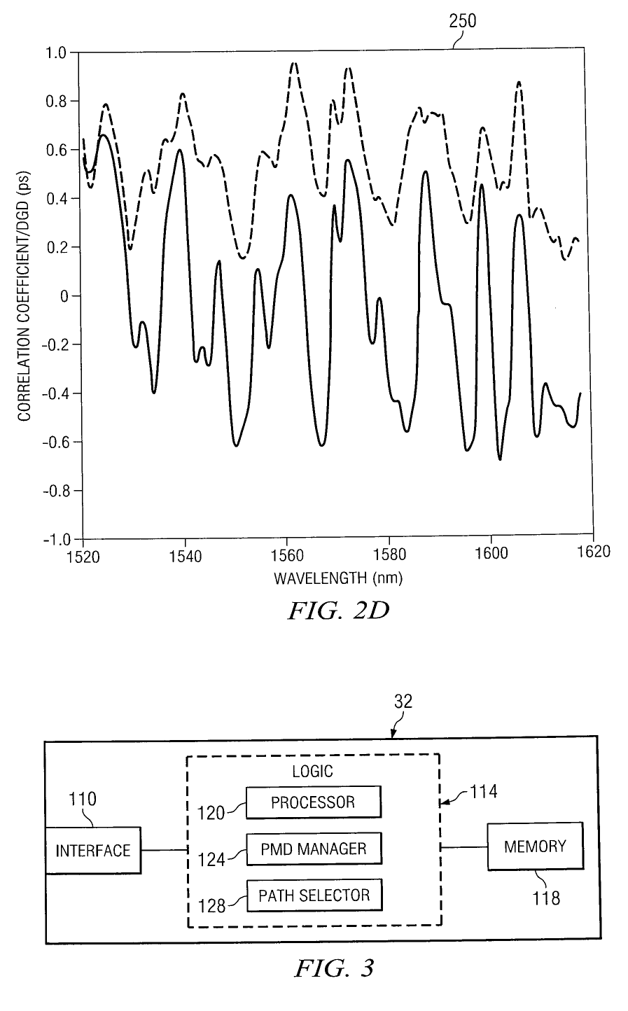

FIGS. 2A through 2D illustrate examples of the dependency of differential group delay on wavelength. FIG. 2A is a graph 210 that illustrates an overwritten differential group delay spectrum based on measurements taken over a week. Any suitable number of measurements may be taken, such less than 1,000, 1,000 to 10,000, 10,000 to 20,000, or 20,000 or more. Graph 210 shows twenty-two curves chosen from the actual measured curves. Each curve is taken at an 8-hour interval. Graph 210 indicates that differential group delay exhibits statistical behavior and is wavelength dependent.

FIG. 2B is a graph 220 illustrating experimentally measured maximum 222, minimum 224, and average 226 differential group delay over time as a function of the wavelength. FIG. 2C is a graph 230 illustrating the data of graph 220 for a smaller range of wavelengths that may be used in particular optical networks. Second order PMD (SOPMD) also exhibits wavelength dependency.

FIG. 2D is a graph 250 illustrating the correlation between ambient temperature change and temporal differential group delay changes of each wavelength. Positive 1 represents a perfect correlation, a negative 1 represents perfect opposite correlation, and zero represents no correlation between the two. Certain wavelengths exhibit high correlation around 0.6, corresponding to local DGD maximum. Other wavelengths exhibit low correlation around negative 0.6, corresponding to local DGD minimum. These effects indicate that at the local DGD maximum and minimum, differential group delay changes according to the ambient temperature with positive or negative correlation.

FIG. 3 illustrates one embodiment of PMD module 32 that may select paths according to differential group delay. The operations of PMD module 32 may be performed by one or more apparatuses, such as by a node 20, network management system 30, and/or other apparatus. In the illustrated embodiment, PMD module 32 includes an interface 110, logic 114, and memory 118. Logic 114 includes a processor 120, a PMD manager 124, and a path selector 128.

Logic 114 manages the operation of PMD module 32. In particular embodiments, PMD manager 124 manages the polarization mode dispersion information of network 10. PMD manager 124 may obtain, store, and/or distribute polarization mode dispersion information. For example, PMD manager 124 may measure polarization mode dispersion and/or access a database that includes polarization mode dispersion information.

In particular embodiments, PMD manager 124 measures polarization mode dispersion for each wavelength of a route using a Jones-Matrix Eigen-Analysis. Measurements of differential group delay may be substantially continuously or periodically taken to determine polarization mode dispersion.

In particular embodiments, polarization mode dispersion may be determined using a light source, such as a tunable laser, and a polarimeter. The wavelength of the tunable laser may be swept from 1,520 to 1,620 nanometers at a rate of 20 nanometers per second. Data may be recorded at 0.2 nanometer increments for a total of 490 measurement wavelengths. Differential group delay may be measured approximately every 60 seconds. The mean or average differential group delay over wavelength may be referred to as a polarization mode dispersion.

In particular embodiments, path selector 128 selects a path according to the polarization mode dispersion of the wavelengths of the paths. A path may be selected in any suitable manner. For example, a wavelength with an acceptable polarization mode dispersion may be selected for a specific high bit rate signal. Acceptable polarization mode dispersion values may be in the range less than 0.5, 0.5 to 1.0, 1.0 to 1.5, 1.5 to 2.0, or 2.0 or greater. As another example, path selector 128 may order routes according to the differential group delay (or other PMD value) for particular wavelengths, and selecting the route with the lowest differential group delay according to the ordering.

In particular embodiments, path selector 128 may remove from consideration paths that fail to satisfy a criteria. Examples of criteria include the maximum tolerated chromatic dispersion, the filter bandwidth, the maximum tolerated amplified spontaneous emission (ASE) accumulation, and the maximum tolerated interference between channels.

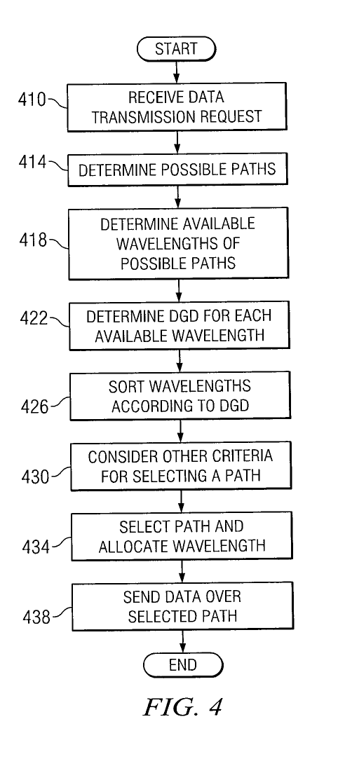

FIG. 4 illustrates one embodiment of method that may be performed by PMD module 32 to select paths according to differential group delay. A data transmission request is received for a communication between a source node 22 and a destination node 22 at step 410.

Possible paths between the source and destination nodes 22 are determined at step 414. Network management system 30 or source node 22 may determine the paths. Available wavelengths of the possible paths are determined at step 418. The differential group delay for each available wavelength of the possible paths are determined at step 422. The wavelengths are sorted according to differential group delay at step 426.

One or more criteria for selecting a path are taken into account at step 430. Criteria may include, for example, maximum tolerated chromatic dispersion, filter bandwidth, maximum tolerated ASE accumulation, maximum tolerated interference with other channels, or any other appropriate criterion. A path is selected and wavelength is allocated according to the differential group delay and criteria at step 434. Data is sent over the selected path using the allocated wavelength at step 438.

Modifications, additions, or omissions may be made to the systems and apparatuses described herein without departing from the scope of the invention. The components of the systems and apparatuses may be integrated or separated. Moreover, the operations of the systems and apparatuses may be performed by more, fewer, or other components. Additionally, operations of the systems and apparatuses may be performed using any suitable logic. As used in this document, “each” refers to each member of a set or each member of a subset of a set.

Modifications, additions, or omissions may be made to the methods described herein without departing from the scope of the invention. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

What is claimed is:

1. A computer-readable medium having computer-executable instructions, when executed by a computer configured to:
facilitate communication through a plurality of routes among a plurality of nodes, each route associated with a plurality of wavelengths, each route comprising one or more segments, a segment coupling one node to another node;
determine a polarization mode dispersion value for each wavelength of each route of the plurality of routes to yield a plurality of polarization mode dispersion values for the each route; and
select a wavelength and a route according to the polarization mode dispersion values of the plurality of wavelengths.

2. The computer-readable medium of claim 1, the instructions when executed further configured to determine a polarization mode dispersion value for each wavelength of each route by:
measuring differential group delay for the each wavelength; and
determining a polarization mode dispersion value for the each wavelength from the differential group delay for the each wavelength.

3. The computer-readable medium of claim 1, the instructions when executed further configured to determine a polarization mode dispersion value for each wavelength of each route by:
determining differential group delay for the each wavelength; and
determining the polarization mode dispersion value for the each wavelength from the differential group delay for the each wavelength.

4. The computer-readable medium of claim 1, the instructions when executed further configured to determine a polarization mode dispersion value for each wavelength of each route by:
receiving polarization mode dispersion information; and
determining the polarization mode dispersion value for the each wavelength from the polarization mode dispersion information.

5. The computer-readable medium of claim 1, the instructions when executed further configured to select a wavelength and a route according to the polarization mode dispersion values by:
ordering the routes according to the polarization mode dispersion values of the wavelengths of the routes; and
selecting the route in accordance with the ordering.

6. The computer-readable medium of claim 1, the instructions when executed further configured to select a wavelength and a route according to the polarization mode dispersion values by:
selecting the route with the lowest polarization mode dispersion values of the wavelengths.

7. The computer-readable medium of claim 1, the instructions when executed further configured to select a wavelength and a route according to the polarization mode dispersion values by:
removing from consideration one or more routes that fail to satisfy a criterion selected from a group consisting of:
a maximum tolerated chromatic dispersion;
a filter bandwidth;
a maximum tolerated amplified spontaneous emission (ASE) accumulation; and
a maximum tolerated interference.

8. The computer-readable medium of claim 1, the instructions when executed further configured to:
transmit polarization mode dispersion information to at least one node of the plurality of nodes.

9. The computer-readable medium of claim 1, each route comprising more than one segment from a source node to a destination node.

10. The computer-readable medium of claim 1, each route comprising one segment from one node to a next node.

11. A method comprising:
facilitating communication through a plurality of routes among a plurality of nodes, each route associated with a plurality of wavelengths, each route comprising one or more segments, a segment coupling one node to another node;
determining a polarization mode dispersion value for each wavelength of each route of the plurality of routes to yield a plurality of polarization mode dispersion values for the each route; and
selecting a wavelength and a route according to the polarization mode dispersion values of the plurality of wavelengths.

12. The method of claim 11, the determining a polarization mode dispersion value for each wavelength of each route further comprising:
measuring differential group delay for the each wavelength; and
determining a polarization mode dispersion value for the each wavelength from the differential group delay for the each wavelength.

13. The method of claim 11, the determining a polarization mode dispersion value for each wavelength of each route further comprising:
determining differential group delay for the each wavelength; and
determining the polarization mode dispersion value for the each wavelength from the differential group delay for the each wavelength.

14. The method of claim 11, the determining a polarization mode dispersion value for each wavelength of each route further comprising:
receiving polarization mode dispersion information; and
determining the polarization mode dispersion value for the each wavelength from the polarization mode dispersion information.

15. The method of claim 11, the selecting a wavelength and a route according to the polarization mode dispersion values further comprising:
ordering the routes according to the polarization mode dispersion values of the wavelengths of the routes; and
selecting the route in accordance with the ordering.

16. The method of claim 11, the selecting a wavelength and a route according to the polarization mode dispersion values further comprising:
selecting the route with the lowest polarization mode dispersion values of the wavelengths.

17. The method of claim 11, the selecting a wavelength and a route according to the polarization mode dispersion values further comprising:
removing from consideration one or more routes that fail to satisfy a criterion selected from a group consisting of:
a maximum tolerated chromatic dispersion;
a filter bandwidth;
a maximum tolerated amplified spontaneous emission (ASE) accumulation; and
a maximum tolerated interference.

18. The method of claim 11, further comprising:
transmitting polarization mode dispersion information to at least one node of the plurality of nodes.

19. The method of claim 11, each route comprising more than one segment from a source node to a destination node.

20. The method of claim 11, each route comprising one segment from one node to a next node.
